(19) United States
(12) Patent Application Publication
(10) Pub. No.: US 2016/0185667 A1
(43) Pub. Date: Jun. 30, 2016

(54) METHOD OF MANUFACTURING ALUMINA-BASED MILLING MEDIUM

(71) Applicants: Gideon Shikolsky, Kiryat Motzkin (IL); Eitan Dafny, Kiryat Ata (IL); Michael Bonan, Rekhasim (IL); Nir Moscovitch, Beer Sheva (IL); Nikolay Fux, Beer Sheva (IL); Roland Mureinik, Jerusalem (IL); Ariel Peleg, Lehavim (IL)

(72) Inventors: Gideon Shikolsky, Kiryat Motzkin (IL); Eitan Dafny, Kiryat Ata (IL); Michael Bonan, Rekhasim (IL); Nir Moscovitch, Beer Sheva (IL); Nikolay Fux, Beer Sheva (IL); Roland Mureinik, Jerusalem (IL); Ariel Peleg, Lehavim (IL)

(21) Appl. No.: 14/128,708

(22) PCT Filed: Jun. 21, 2012
(86) PCT No.: PCT/IL2012/000251

§ 371 Date: Mar. 2, 2016

(30) Foreign Application Priority Data
Jun. 23, 2011 (IL) 213757

(51) Int. Cl. C04B 35/111; C04B 35/626; F41H 5/00; C04B 35/638; C04B 35/645; B02C 17/20; C04B 35/634

(52) U.S. Cl. CPC C04B 35/111; B02C 17/20; C04B 35/6263; C04B 35/63416; C04B 35/63408; C04B 35/638; C04B 35/645; F41H 5/00; C04B 2235/3206; C04B 2235/786; C04B 2235/3826

(57) ABSTRACT

The invention provides a cost effective and environmentally friendly process of manufacturing alumina-based, impact-resistant and wear-resistant ceramic objects from alumina of a lower purity. Particularly, the objects may serve as milling and grinding media, or as superior materials for ballistic and armor protection.

### FIELD OF THE INVENTION

The present invention relates to alumina-based ceramic objects produced by an environmentally friendly and economic process, for use as construction and functional objects in various applications. Particularly, the objects may serve as milling and grinding media, or as superior materials for ballistic and armor protection.

### BACKGROUND

Ceramics are materials, which are made of nonmetallic minerals, usually in the form of metallic oxides that have been permanently hardened by firing at a high temperature. Traditional ceramics are made of alumina, magnesia, clay and other naturally occurring materials, while modern ceramic objects are made of silicon carbide, zirconia, boron nitride, and other specially purified or synthetic raw materials. In general, traditional low-cost ceramics are characterized by inferior properties. Therefore, extensive R&D work has aimed at improving the properties of the traditional ceramics, and at providing ceramics having improved properties at lower cost.

Processing of ceramic materials comprises steps of i) preparing a raw mixture of ceramic powder, said raw powder mixture being called “ready to press powder”, or RTP, ii) pressing the RTP into a body of desired shape, said body being called “green body”, and iii) firing the green body below the melting temperature of the ceramic, said firing being called “sintering”. This method is subject to various modifications and often includes adding glue and lubricants to the RTP mixture prior to making the green body in order to increase the powder lubrication, followed by burning the glue and lubricants at elevated temperatures prior to or during the sintering stage.

Among the frequently used materials in the field of ceramics is alumina (aluminum oxide) due to its relatively high hardness and its relatively low cost. Sintered alumina-based ceramic bodies or objects, referred to shortly as ceramic bodies, are applied in various applications for example in grinding media, heat resistant bricks, ballistic protection, fusion vessels, and in various other uses. Many techniques require the use of very pure alumina as a raw material. It is an object of the invention to provide a method for manufacturing ceramic bodies while utilizing alumina of lower purity at lower cost.

It is further an object of the present invention to provide ceramic objects having high impact and wear resistance.

It is also an object of the present invention to provide ceramic objects, suitable particularly as milling and grinding media.

It is another object of the present invention to provide ceramic objects, suitable particularly for ballistic and armor protection.

This and other objects of the present invention shall become clear as the description proceeds.

### SUMMARY OF THE INVENTION

The invention provides an environmentally friendly process of manufacturing alumina-based, impact-resistant and wear-resistant ceramic objects from alumina having the purity of 99.9% or less, comprising i) mixing alumina containing 99.9% or less of Al₂O₃, aqueous magnesium bicarbonate solution, and lubricants soluble in water, thereby obtaining an alumina suspension; ii) removing liquid from said suspension, whereby forming a ready to press (RTP) powder; iii) forming green bodies by placing the RTP powder into suitable molds with the desired dimensions and then applying the required pressure; iv) heating said green bodies in an appropriate furnace at a temperature between 600° C. and 1100° C., whereby removing essentially all of said lubricants; and v) sintering the heated green bodies obtained in step iv at a temperature between 1100° C. and 1600° C., resulting in said ceramic objects; wherein no halogen-containing gases or corrosive side products are released during said steps of heating and sintering. The invention enables to employ alumina of lesser quality, for example alumina containing 99.9 wt % Al₂O₃ or less, such as about 99.8 wt % Al₂O₃, or in other embodiment alumina containing 99.7 wt % Al₂O₃ or less, such as about 99.6 wt %, or in another embodiment alumina containing 99.5% Al₂O₃ or less. Said lubricants may comprise, for example, polyalkyleneglycol or polyvinylalcohol. The term “lubricants”, as used in the instant description, includes materials which act as glue and/or lubricant in the mixture before sintering. In one embodiment, the lubricant comprises polyvinylalcohol or polyethyleneglycol or polypropylene glycol.

The invention relates to alumina-based ceramic objects generated by pressing and heating from a mixture comprising magnesium bicarbonate, alumina containing 99.9% or less of Al₂O₃, and a lubricant selected, for example, from polyalkyleneglycol and polyvinylalcohol. The invention further relates to a mixture for pressing to form a green body, and for sintering to form the said ceramic objects, which mixture comprises alumina containing 99.9% or less of Al₂O₃, magnesium bicarbonate, lubricants, and a liquid medium, wherein said lubricants are soluble in said liquid medium. Said liquid medium is preferably water. The ceramic objects of the invention have preferably a hardness of 1850 ITV or more and a density of 3.9 g/cm3 or more. The ceramic objects of the invention contain MgO, preferably in an amount of from 0.1 wt % to 0.6 wt %. The ceramic sintered objects according to the invention exhibit, when examined by the Scanning Electron Microscope, grains having an average size of 5 μm or less. Said MgO, formed from magnesium bicarbonate, is predominantly bound in a spinel layer formed during said heating, and mainly covers the interface area between adjacent grains.

In one preferred embodiment, the invention provides, by a cost effective and environmentally friendly method, ceramic objects which are milling and grinding media characterized by an excellent wear resistance, showing mass loss of 3% or less in wear resistance tests. In other preferred embodiment, the invention provides, by a cost effective and environmentally friendly method, impact resistant bodies for ballistic protection, which exhibit a superior fracture toughness and which show excellent ballistic results, like low residual penetration values in comparative shooting tests.

### DETAILED DESCRIPTION OF THE INVENTION

It has now been surprisingly found that including magnesium bicarbonate in a precursor mixture for making alumina-based ceramic objects enables to obtain a superior grinding medium and ballistic protection bodies, even if employing alumina of lower purity, whereas the whole process is, in addition, environmentally more friendly. Magnesium halide salts and organic salts were used as grain growth-inhibitors in making alumina-based ceramics (WO 2007/029237). The present invention provides ceramic milling and grinding media by employing magnesium bicarbonate, the media combining qualities of high hardness and high density with low porosity, and further exhibiting high impact resistance and wear resistance. This water soluble salt of magnesium is not generally available as an isolated salt, as it is difficult to control its concentration in view of its inherent instability.

The invention provides alumina-based ceramic objects having high impact, high hardness, and high wear resistance generated from a mixture comprising alumina and magnesium bicarbonate by pressing and heating, wherein said alumina preferably contains 99.9 wt % or less Al₂O₃. Many of the known processes for manufacturing alumina-based ceramic bodies require a highly pure alumina, which makes them very expensive. The instant alumina-based ceramic body may comprise even cheap alumina having purity as low as, for example, about 99.5 wt % or less, which is surprisingly enabled by incorporating magnesium bicarbonate into the working mixture. The precursor RTP mixture for making the ceramic objects of the invention comprises alumina, magnesium bicarbonate, a glue and lubricants, and a liquid medium, wherein said glue and lubricants are soluble in said liquid medium. Said glue and lubricants may comprise, for example, polyalkyleneglycol or polyvinylalcohol. The ceramic objects of the invention have usually hardness of 1850 HV or more (according to the Vickers method, upon application of a load of 10 kilograms) and a density of 3.9 g/cm³ or more. Said precursor mixture is pressed and shaped into a green body, wherein said pressing preferably follows drying and removing most of said liquid medium. Usually, the whole process of making the ceramic objects of the invention involves multiple heating steps, at different temperatures, which results in creating a ceramic body. In a preferred embodiment of the invention, said ceramic body comprises grains of an average size of 5 μm or less (according to the Scanning Electron Microscope method). During the sintering process, spinel (MgAl₂O₄) is formed, and it concentrates mainly on the surface of said grains or on the grain interface. In one aspect of the invention, the ceramic objects are milling and grinding media constituted by essentially spherical ceramic bodies. The milling and grinding media of the invention may comprise alumina-based, impact- and wear-resistant balls of desired size. The media may comprise other shapes, for example including various beads, cylinders, discs, or plates. The invention is directed to a mixture to be pressed into a green body, comprising alumina, magnesium bicarbonate, glue and lubricants, and a liquid medium, wherein said glue and lubricants are soluble in said liquid medium while the alumina is not soluble. Said mixture may have a consistence of a suspension, paste, or a powder, depending on the amount of the liquid medium removed from the mixture. Said lubricants are wax-like materials, for example polyvinyl alcohol and/or polyethylene glycol, such as PEG 3000.

The invention provides an environmentally friendly process of manufacturing alumina-based, impact resistant and wear resistant, ceramic objects, such as milling and grinding media or ballistic protection bodies, comprising i) preparing a mixture comprising alumina containing 99.9 or less wt % of Al₂O₃, magnesium bicarbonate, a glue and a lubricants, and a liquid medium, and wherein said glue and said lubricants are soluble in said liquid medium; ii) removing said liquid medium, whereby forming a ready to press (RTP) powder; iii) forming green bodies by placing the RTP powder into suitable molds with the desired dimensions and then applying the required pressure; iv) heating said green bodies in an appropriate furnace at a temperature between 600° C. and 1100° C., whereby removing essentially all of said glue and lubricants (“de-waxing”), and residues of said liquid medium; and v) sintering the heated green bodies obtained in step iv at a temperature between 1100° C. and 1600° C., resulting in ceramic bodies, such as, for example milling and grinding media. Said liquid medium may comprise organic liquids, inorganic liquids, and mixtures thereof; however, in a preferred embodiment of the process of the invention, said medium is water, which makes the whole process safer and still more environmentally friendly. Said alumina may contain 99.5 or less wt % of Al₂O₃. In a preferred embodiment of the invention, the process obviates contaminating the environment with halogen and/or hydrogen halide gases, such as chlorine, fluorine, hydrochloric acid, and hydrofluoric acid, which are often released during similar processes when chloride and fluoride salts are included in the heated mixtures, for example as grain growth inhibitor. The invention enables the use of lower grade alumina materials, for example containing up to 0.5% impurities.

The invention relates to a process comprising the steps of premixing the raw materials to form a raw suspension, drying the suspension to form a ready-to-press (RTP) powder, shaping the powder to form green bodies, and sintering the green bodies to form ceramic objects. Said raw suspension contains magnesium bicarbonate. Said raw suspension, said RTP powder, and said green bodies as well, are provided as separate aspects of the present invention. Said raw suspension is preferably a mixture comprising alumina, magnesium bicarbonate, a glue and lubricants, and a liquid medium, wherein said liquid medium is preferably water, and wherein said glue and said lubricants are soluble in said liquid medium; by removing said liquid medium, an RTP powder is formed. The method enables to employ an alumina material of lower purity, such as alumina comprising 99.9 wt % Al₂O₃ or less, The method enables to employ an alumina material comprising 99.8 wt % Al₂O₃ or less, or alumina comprising 99.7 wt % Al₂O₃ or less, or alumina comprising 99.6 wt % Al₂O₃ or less, or alumina comprising 99.5 wt % Al₂O₃ or less. In a preferred embodiment of the invention, the RTP is a free flowing powder obtained by spray drying. The process of the invention is an environmentally friendly, economical process, providing alumina-based ceramic objects which exhibit high wear resistance and high corrosion resistance, and which withstand high temperatures. In a preferred embodiment, the process of the invention provides ceramic bodies for use as milling and grinding media and/or in ballistic protection, exhibiting high impact resistance and high wear resistance even when employing alumina of lower purity.

The superior ceramic objects of the invention may be used as construction and functional parts in machines, engines, and devices, and as implants in joint replacement surgery. The objects may serve as mechanical or electronic parts, as armor components and in ballistic protection, as chemically stable lining, as mechanically stable sealing, as thermally and chemically stable vessels for fusion and casting, as hard components in metal machining or powder milling, as strong and electrically non-conductive parts in electronics, and wear-resistant parts exposed to long-term friction like combustion engine parts. The objects of the invention may comprise large ceramic bodies, thin ceramic layers, or composite materials. The objects of the invention will be utilized, for example, in chemical industry, paint industry, textile industry, pharmaceutical industry, metal processing, machinery, automotive industry, electronics, medical technology, and defense industry.

Ceramic bodies of the invention constitute, in one embodiment, milling and grinding medium. The milling and grinding medium of the invention is formed, in a preferred embodiment, in a process comprising the steps of premixing the raw materials to form a raw suspension, drying the suspension to form a ready-to-press (RTP) powder, shaping the powder to form green bodies, and sintering the green bodies to form ceramic milling and grinding medium. Said raw suspension contains magnesium bicarbonate. Said raw suspension, said RTP powder, and said green bodies as well, are provided as separate aspects of the present invention. Said raw suspension is preferably a mixture comprising alumina, such as containing between 99.5 and 99.9 wt % or less Al₂O₃, magnesium bicarbonate, a glue and lubricants, and a liquid medium, wherein said liquid medium is selected from organic liquids, inorganic liquids, and mixtures thereof, and wherein said glue and said lubricants are soluble in said liquid medium; by removing said liquid medium, an RTP powder is formed. In a preferred embodiment of the invention, the RTP is a free flowing powder obtained by spray drying.

The use of magnesium bicarbonate in the raw suspension of alumina results in unexpectedly good ceramic milling and grinding media and ballistic components. Without wishing to be bound by any theories, it is believed that soluble magnesium salt acts in the present process both as a grain growth inhibitor and as a source of cations for creating the spinel layer uniformly covering the microscopic grains formed during the sintering process and being found in the final ceramic bodies, whereas the inherent instability of magnesium bicarbonate positively affects the whole process of ceramics formation through all heating stages. It is assumed that alumina particle is covered with a small quantity of magnesium bicarbonate, which is decomposed upon heating, thus creating on the surface of the alumina particles a “coat” of highly reactive magnesium oxide, which in turn reacts with the adjacent alumina surface forming a uniform surface layer of spinel. So, under the temperature conditions prevailing during the heating step, magnesium bicarbonate produces magnesia which reacts with alumina during said de-waxing stage, finally producing spinel (Al₂MgO₄) during the sintering stage. Finished ceramic milling and grinding media of the present invention, therefore, acquire the desired mechanical properties, especially high hardness and high density combined with low porosity, resulting in the desired impact and wear stabilities. Magnesium bicarbonate, formed as magnesia dissolved in carbonated water, provides the magnesia needed for the formation of spinel without releasing undesired side products which contaminate the environment or damage the manufacturing equipment due to their corrosiveness.

The raw materials used in the RTP powder of the present invention include: a) alumina powder, b) grain growth inhibiting material, particularly magnesium bicarbonate, including its hydrates, c) a glue and lubricants, and d) a liquid medium. The alumina powder need not be of the highest purity, it may contain impurities in an amount of, for example, 0.1 wt % or more, or 0.2 wt % or more, or 0.3 wt % or more, or 0.4 wt % or more, or 0.5 wt % or more.

The process for preparing ceramic bodies, for example milling and grinding media and ballistic components, in accordance with the present invention starts with preparing the raw materials mixture and ends with sintering shaped objects. The first stage of the process includes the preparation of the raw suspension. The raw materials include alumina, grain growth inhibiting material, and glue and lubricants, in a liquid medium which may be an organic liquid, an inorganic liquid, or a mixture thereof, whereas the liquid medium is able to dissolve the grain growth inhibiting material, and the glue and lubricants, but not the alumina; the medium preferably comprises water. The next stage of the process includes the removal of most of the liquid medium, obtaining an RTP powder, which is pressed to provide green bodies of desired dimensions. After this step, essentially all of the glue and lubricants, and the liquid medium residues, are removed from the mixture by heating.

The last stage is the sintering stage, in which the desired advantageous ceramic objects are obtained.

It is important to maintain the optimal ratio between the overall surface area of the alumina and the weight of the dissolved materials in the raw suspension in order to ensure optimal coating of the alumina particles.

In summary, the above process comprises the following main five stages:

i. Preparation of the raw materials mixture;

ii. Removal of the liquid medium;

iii. Pressing; and

iv. De-waxing and sintering.

These stages will now be described in further detail with reference to a preferred embodiment of the invention.

i. Preparation of the raw materials mixture: In this stage homogeneous liquid slurry is prepared which comprises, besides alumina, a liquid medium, a grain growth inhibiting material, and glue and lubricants. A method for achieving the slurry uses a ball mill and is carried out according to the following steps:
a) adding the liquid medium to the ball mill;
b) adding the grain growth inhibiting material and mixing;
c) adding the glue and lubricants and mixing; and
d) adding alumina and mixing.

ii. Removal of the liquid medium: Removing most or all of the liquid medium and obtaining a free flowing RTP powder, for example by using a spray drier.

iii. Pressing: In this stage, green bodies are formed by placing the RTP powder into a suitable mold with the desired dimensions and then applying the required pressure, such as between 500 atm and 2000 atm, by using a suitable press.

iv. De-waxing and sintering: Removing essentially all or all of the glue and lubricants material and Liquid Medium residues in the Green Bodies by heating in an appropriate furnace at 600° C.-1100° C. Magnesium grain growth inhibiting materials are converted to magnesia during this stage, and a small amount of carbon dioxide is released. Similar heating stages in many known sintering processes lead to the release of harmful gases comprising halogen or sulfur. The so formed magnesia then reacts with the alumina at the alumina grain boundaries, resulting in the formation of spinel:

MgO+Al₂O₃→MgAl₂O₄
The finished ceramic bodies are obtained by sintering at a temperature between 1100° C. and 1600° C., the bodies used as superior milling and grinding media, or ballistic components.

The magnesia content in the sintered product, incorporated in the spine' phase, is preferably from 0.1 wt % to 0.6 wt %. In one embodiment, the MgO content in the ceramic objects of the invention is 0.1 wt %. In other embodiment, the MgO content in the ceramic objects of the invention is 0.5 wt %.

The heating stages may be effected in the ambient air under normal pressure. In a preferred embodiment, said liquid medium is water, and said RTP powder obtained in the above stage ii) contains not more than about 0.5% of water, as determined by the loss on drying.

In another preferred embodiment, when the liquid medium is water, then the RTP powder obtained in the above stage contains not more than about 2% of organic material and water, as determined according to the loss on ignition when heating to a temperature of 1000° C. for 2 hours.

In a preferred embodiment of the present invention, the ceramic bodies are shaped as balls suitable for use as grinding media. In other preferred embodiment of the present invention, the ceramic bodies are shaped in several forms for use in ballistic protection. Hardness of the bodies is preferably not less than about 1850 HV (according to the Vickers method) upon application of a load of about 10 kilograms, their density not less than about 3.9 g/cm³ or greater, such as 3.95 g/cm³ (according to the Archimedes method or the pycnometer method), and their average grain size is smaller than 5 μm, preferably smaller than about 2.5 μm (according to the Scanning Electron Microscope method). The wear resistance is significantly higher when compared to similar commercial materials. When compared to milling and grinding medium manufactured by the same process but using very pure alumina, the media according to the invention exhibit the same impact resistance and wear resistance.

Thus, the invention provides alumina-based ceramic objects generated from a mix comprising alumina and magnesium bicarbonate by pressing and heating, wherein said alumina may contain between 99.5 and 99.9 or less wt % of Al₂O₃, and wherein the process generating said ceramic objects is environmentally friendly. Said process comprises steps of preparing a mixture of alumina, magnesium bicarbonate, glue and lubricants, and liquid medium, said glue being in amounts of from 0.5 to 2%, removing said medium, forming green bodies and heating them, and sintering the bodies. Environmentally adverse materials are excluded from the process, and the manufacturing equipment is less affected by damages due to contacting adverse materials. The new process enables to employ regular construction materials for the equipment, as corrosive side products are not formed during the process according to the invention. The product has advantageous surface properties, including low porosity.

### EXAMPLES

The following exemplifies, without limiting the scope of the invention, illustrate some aspects of the present invention:

### Measurement and Test Methods

Density was measured by Archimedes method or in gas pycnometer, and was usually equal to or greater than 3.9 g/ml.

Porosity was determined by the subtraction of the measured density from the theoretical density, as can be found in the relevant literature.

Presence of cracks was detected by a colored ink penetration test.

Hardness was measured by Vickers method, as HV, at a load of 10 kg. Fracture toughness (FT) was characterized as MC. Hardness tester AVK-C2 was employed for measuring HV and KIC.

Grain size was determined by SEM method. Usually, the grain diameter distribution had D₅₀<2 μm, 100%<5 μm.

The ceramic bodies made according to the invention were found to be usually by about 50% harder than commercial alumina-based milling and grinding medium tested by the same method. The ceramic bodies made according to the invention were also found to be harder than commercial alumina-based ballistic protection elements.

### Example 1

### Preparation of the Raw Material Mixture

Water and dissolved magnesium bicarbonate are introduced into a ball mill having zirconia milling balls and the ball mill is operated for several minutes. Then, glue and lubricants are introduced and the ball mill is operated again for several minutes more. Finally, the alumina is introduced and the mill is operated in order to de-agglomerate the alumina powder until a homogeneous slurry is formed. The preparation of the raw suspension is performed under normal room conditions (temperature of about 25° C.).

The liquid medium may be removed by methods known in the art, for example by means of a spray drier.

### Example 2

### Properties of Ballistic Plates and Cylinders

Tiles and cylinders were prepared in accordance with the invention, and their density, hardness, grain size (D₅₀), and fracture toughness as K_{I}C were measured. The following table includes four different tiles and cylinders samples. Sample 1 includes 50×50×6 mm tiles, sintered in a laboratory kiln at 1570° C. for 2 hours. Sample 2 includes 50×50×7 mm tiles, sintered in a laboratory kiln at 1570° C. for 2 hours. Sample 3 includes 50×50×7 mm tiles, sintered in an industrial kiln at 1570° C. for 2 hours. Sample 4 includes φ19×14 mm cylinders, sintered in a laboratory kiln at 1570° C. for hours. Table 1 shows the material characteristics, each values is the average of three measurements.

Destructive test results, based on comparative shooting tests developed by the inventors, showed Residual Penetration of 0.54 mm for the plates according to the invention, with a standard deviation of 0.22 mm, versus Residual Penetration of 3 mm for commercial ballistic 98% alumina of the same dimensions, shape and weight.

TABLE 1

| Sample | Density | Hardness | D₅₀ | FT |
|---|---|---|---|---|
| No. | (g/cm³) | as HV | (μm) | as K_{I}C |
| 1 | 3.94 | 1919 | 3-5 | 3.5-4 |
| 2 | 3.94 | 1862 | 3 | 3.5-4 |
| 3 | 3.91 | 1827 | 3 | 3.5-4 |
| 4 | 3.94 | 1906 | 3-5 | 3.5-4 |

### Example 3

### Examining Wear Resistance

Four alumina milling and grinding media were compared: three commercial samples (1-India; 2-China; 3-Israel) and a sample produced according to the invention (4). Table 2 shows the values of density, hardness, and wear resistance. The wear resistance was determined by stirring 1 kg of alumina milling balls with 0.5 liter water and 120 g SiC powder for 24 hours. The wear was expressed as the loss of weight.

TABLE 2

| Sample | Density | Hardness | Wear |
|---|---|---|---|
| No. | (g/cm3) | HV | (%) |
| 1 | 3.91 | 1450 | 3.2 |
| 2 | 3.84 | 1140 | 9.5 |
| 3 | 3.89 | 1150 | 5.58 |
| 4 | 3.90 | 1900 | 1.91 |

The results show that the alumina objects prepared according to the invention exhibit better hardness and wear resistance than objects prepared according to the prior art methods.

While examples of the invention have been described for purposes of illustration, it will be apparent that many modifications, variations and adaptations can be carried out by persons skilled in the art, without exceeding the scope of the claims.

1-11. (canceled)

12. An environmentally friendly process of manufacturing alumina-based, impact-resistant and wear-resistant ceramic objects from alumina having a purity of between 99.5% and 99.9%, comprising
i) mixing alumina containing between 99.5% and 99.9% of Al₂O₃, aqueous magnesium bicarbonate solution, and lubricants soluble in water, thereby obtaining an alumina suspension;
ii) removing liquid from said suspension, whereby forming a ready to press (RTP) powder;
iii) forming green bodies by placing the RTP powder into suitable molds with the desired dimensions and then applying the required pressure;
iv) heating said green bodies in an appropriate furnace at a temperature between 600° C. and 1100° C., whereby removing essentially all of said lubricants; and
v) sintering the heated green bodies obtained in step iv at a temperature between 1100° C. and 1600° C., resulting in said ceramic objects; wherein no halogen-containing gases or corrosive side products are released during said steps of heating and sintering;
wherein said impact-resistant and wear-resistant ceramic objects are characterized by a hardness of at least 1900 HV and by a wear weight loss of 3% or less when determined by stirring 1 kg of ceramic milling balls with 0.5 liter water and 120 g SiC powder for 24 hours.

13. The process according to claim 12, wherein said sintering comprises a temperature between about 1570° C. and about 1600° C.

14. The process according to claim 12, wherein said lubricants comprise polyalkyleneglycol or polyvinylalcohol.

15. Alumina-based impact-resistant and wear-resistant ceramic objects being characterized by a hardness of at least 1900 HV and by a wear weight loss of 3% or less when determined by stirring 1 kg of ceramic milling balls with 0.5 liter water and 120 g SiC powder for 24 hours, the ceramic objects being generated by pressing, heating, and sintering at a temperature between 1100° C. and 1600° C., from a mixture comprising magnesium bicarbonate, alumina containing between 99.5% and 99.9% of Al₂O₃, and a lubricant selected from polyalkyleneglycol and polyvinylalcohol.

16. A mixture for pressing to form a green body, and for sintering to form the ceramic objects of claim 15, comprising alumina containing between 99.5% and 99.9% of Al₂O₃, magnesium bicarbonate, lubricants selected from polyalkyleneglycol and polyvinylalcohol, and an aqueous medium.

17. The ceramic objects of claim 15, having a hardness of about 1900 HV or more and a density of 3.9 g/cm³ or more.

18. The ceramic objects of claim 15, containing MgO in an amount of from 0.1 wt % to 0.6 wt %.

19. The ceramic objects of claim 15, comprising grains having an average size of 5 m or smaller.

20. The ceramic objects of claim 15, containing MgO which is predominantly bound in a spinel layer formed during said heating, covering the interface area of said grains.

21. The objects of claim 15, being impact-resistant bodies for use in ballistic and armor protection.

22. The objects of claim 15, being impact-resistant bodies for use as milling and grinding media.
